(19) United States
(12) Patent Application Publication
(10) Pub. No.: US 2024/0091624 A1
(43) Pub. Date: Mar. 21, 2024

(54) Location and Position-Based Display Systems and Methods

(71) Applicant: Technogym S.p.A., Cesena (IT)

(72) Inventors: Massimiliano Casoni, Cesena (IT); Filippo Casalini, Parma (IT); Alessandro Pasini, Cesena (IT); Enrico Macrelli, Cesena (IT)

(21) Appl. No.: 18/038,429

(22) PCT Filed: Dec. 27, 2021
(86) PCT No.: PCT/IB2021/062334

§ 371 Date: May 23, 2023

(30) Foreign Application Priority Data
Dec. 30, 2020 (WO) PCT/IB2020/062544

(51) Int. Cl. A63B 71/06; G06F 3/14

(52) U.S. Cl. CPC A63B 71/0622; G06F 3/14; A63B 2071/0658

(57) ABSTRACT

A system (200) comprising: a display screen (102; 300) associated with an exercise device (100); a sensor module (112; 304) associated with the display screen (102; 300); and a controller (110; 302) having a processor (116; 308) and memory (118; 310) for storing instructions, the processor (116; 308) executing the instructions to:
based on output of the sensor module (112; 304), detect any one or more of position or proximity of the display screen (102; 300) in relation to the exercise device (100); and
selectively change content displayed on the display screen (102) based on any one or more of the position and/or the proximity.

### FIELD OF THE DISCLOSURE

The present disclosure pertains to display screens, and more particularly, but not by limitation, to display screens that can selectively display content based on display screen position, display screen location, display screen orientation, display screen proximity (e.g., distance from other objects) and/or other display screen parameters. These display screens can be associated with a piece of exercise equipment or a workout facility.

### BACKGROUND

Nowadays, content can be displayed on a display screen of an exercise device for a user during a training session. The content can explain to the user how to carry out the training session on the exercise device.

This type of content is limited to the specific exercise device, which limits the user's training experience, especially in situations where the user is participating in a workout that requires various types of exercise devices, tools, and even bodyweight type exercises.

Therefore, a need is strongly felt today to have available to a user various types of content for a training session that can improve user's training experience in a more reliable and easy way. These improvements include specific configurations of display devices that present different content to a user in a context dependent manner.

### SUMMARY

The object of the present disclosure is to make available to a user various types of content about a training session that can improve the user's training experience in a more reliable and easy way.

The present disclosure can include a system comprising a display screen associated with an exercise device, the display screen that is selectively positionable relative to a frame of the exercise device; a position sensor associated with the display screen; and a controller having a processor and memory for storing instructions, the processor executing the instructions to: determine a position of the display screen in relation to the exercise device; select a first type of content to display on the display screen when the position of the display screen is in a first position; and select a second type of content to display on the display screen when the position of the display screen is in a second position.

The present disclosure can include a device comprising a display screen; a sensor module associated with the display screen; and a controller having a processor and memory for storing instructions, the processor executing the instructions to: based on output of the sensor module, detect any one or more of position or proximity of the display screen in relation to an exercise device; and selectively change content displayed on the display screen based on any one or more of the position and/or the proximity.

The present disclosure can include a method comprising receiving output from a sensor platform associated with a display screen; selecting content for display on the display screen based on at least one of: a position of the display screen in relation to an exercise device; a distance of the display screen in relation to the exercise device; and/or a relative location of the display screen within a workout area.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 depicts an example architecture where the systems and methods of the present disclosure can be implemented.

FIG. 2 depicts a display screen of an exercise device illustrating content based on a position of the display screen.

FIG. 3 is a schematic diagram of an example display screen.

FIG. 4 is a perspective view of an example system that includes a plurality of exercise devices connected to a service provider.

FIG. 5 is a flowchart of an example method of the present disclosure.

FIG. 6 is a flowchart of another example method of the present disclosure.

FIG. 7 is a flowchart of another example method of the present disclosure.

FIG. 8 is a schematic diagram of an exemplary computer system that is used to implement embodiments according to the present technology.

FIG. 9a depicts an exercise device with a display screen in a first position.

FIG. 9b depicts an exercise device with a display screen in a second position.

### DETAILED DESCRIPTION

### Overview

Generally, the present disclosure pertains to display screens that can be configured to display content based on any of their position, orientation, location, or combinations thereof. That is, the display screens allow for the contextualized presentation of content, where the context is based on at least one of position, orientation, location, or combinations thereof.

In some instances, the display screens are associated with exercise equipment. In other instances, the display screens can connect with (both physically and communicatively) with exercise equipment and separate for independent use.

An example display screen can be associated with a sensor module. Example sensor modules can be used to determine a position, orientation, proximity/distance, and/or location of the display screen. In one example, a sensor module can be used to determine if the display screen has been rotated, pivoted, hinged, or otherwise undergone a change in orientation from a first position to a second position.

In particular, according to an embodiment, the sensor module (e.g. a camera), on the basis of a processing of the images which can be collected, is configured to determine if the display screen has been rotated from a first position wherein the display screen is associated with times when the display screen is facing towards a user who is associated with the exercise device and a second position wherein the display screen is associated with times when the display screen is facing towards the user who is positioned away from the exercise device.

In some embodiments, a first type of content can be displayed on the display screen when the display screen is in a first position and a second type of content can be displayed on the display screen when the display screen is in a second position. The sensor module can sense this change in position and output signals that indicate that the display screen has had a change in position.

In another example, the content displayed on a display screen can vary based on proximity or distance calculation from an object such as a user. For example, when a user is within a specified distance a first type of content is displayed. When the user is further than a specified distance a second type of content is displayed.

In yet another example, the content displayed on a display screen can vary based on a relative location of the display screen in a workout area. For example, if the display screen can be moved from location to location in a workout area, the display screen can be configured to display a first type of content when the display screen is in a first location of the workout area (such as a location associated with a workout bike), but a second type of content when the user is in a second location in the workout area (such as an area associated with dumbbells and a mat). These and other advantages of the present disclosure are provided herein with reference to the collective drawings.

### Preferred Embodiments

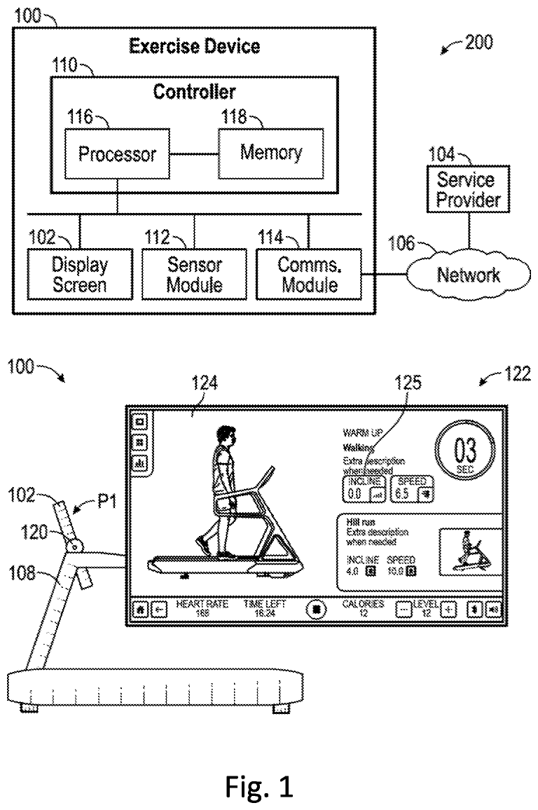

Turning now to the drawings, FIG. 1 depicts an illustrative schematic representation in which techniques and structures for providing the systems and methods disclosed herein may be implemented.

According to FIG. 1, a system 200 comprises an exercise device 100, a display screen 102, a service provider 104, and a network 106. In general, the exercise device 100, the display screen 102, and/or the service provider 104 can communicate with one another through the network 106. The network 106 can comprise combinations of networks that enable the components in the system 200 to communicate with one another. The network 106 may comprise any one or a combination of multiple different types of networks, such as cable networks, the Internet, wireless networks, and other private and/or public networks. In some instances, the network 106 may comprise cellular, Wi-Fi, or Wi-Fi direct.

The exercise device 100 as illustrated comprises a treadmill, although it will be understood that the exercise device 100 can comprise any exercise device such as a rower, a bicycle, and/or other exercise devices that would be known to one of ordinary skill in the art and can comprise both mechanized and non-mechanized exercise equipment such as mats, dumbbells, and the like.

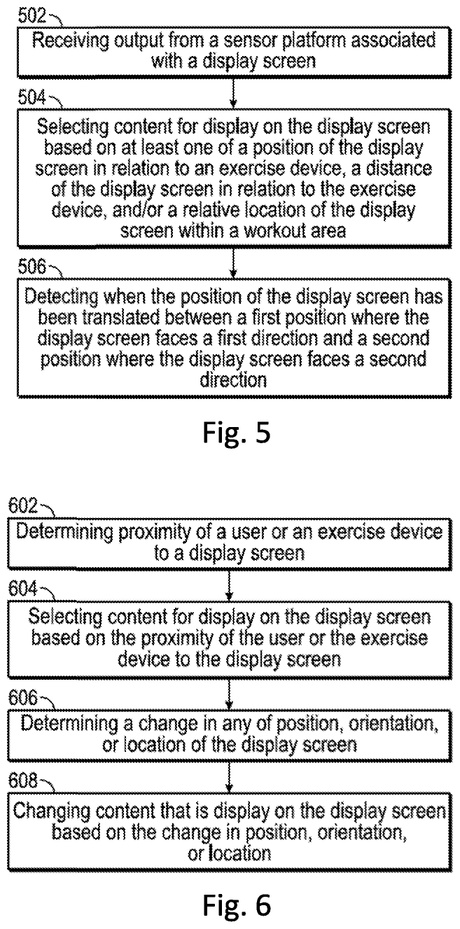

The display screen 102 can be configured to mechanically, electrically, and/or communicatively couple with the exercise device 100. In some embodiments, the display screen 102 can mount to a frame 108 of the exercise device 100 (FIG. 1). In one or more embodiments, the display screen 102 can be permanently associated with the exercise device 100 (FIG. 1). In other embodiments, the display screen 102 can be releaseably associated (connectable/disconnectable) with the exercise device 100 allowing the display screen 102 to be removed and utilized independently of the exercise device 100 (FIG. 4). Thus, while the display screen 102 is illustrated schematically as being part of the exercise device 100, the display screen 102 can be a distinct and separate component from the exercise device 100.

The exercise device 100 can also comprise a controller 110, a sensor module 112, and a communications module 114 that allows the exercise device 100 (and specifically the controller 110) to access and communicate over the network 106. The controller 110 can comprise a processor 116 and memory 118 for storing executable instructions. The processor 116 executes instructions stored in the memory 118 to perform functions such as determining display screen position, proximity, location, orientation, and the like, as well as determining content that should be displayed on the display screen 102. In some embodiments, the exercise device 100 can store and retrieve workout content locally from memory 118. In other embodiments, the exercise device 100 can stream content from the service provider 104.

According to an embodiment, the controller 110 (specifically the processor 116) can comprise a variety of AI (Artificial Intelligence) hardware accelerator types such as graphic processing unit (GPU), tensor processing unit (TPU), neural processing unit (NPU), visual processing unit (VPU).

The AI hardware accelerator may be based on application-specific integrated circuit (ASIC), add-on (es. USB-accelerator), or integrated in the controller 110.

The AI hardware accelerator is configured to perform “motion tracking” of the user, implementing one of more of exercise recognition, exercise classification, repetitions (reps) counting, series counting, pace evaluation, range-of-motion (ROM) evaluation, posture analysis, form feedback, body diagnosis, body segmentation, body recognition, gesture recognition, face recognition, motion detection, motion tracking, pose estimation, skeletal analysis, heart rate (HR) detection, fatigue detection, sex detection, race detection, body mass index (BMI) analysis.

A variety of AI algorithms may be used such as ordinary least-squares regression (OLS), multiple linear regression (MLR), principal component regression (PCR), partial least-squares regression (PLS), Ridge regression (RR), Lasso regression (Lasso), multivariate adaptive regression splines (MARS), stepwise regression (SR), nonlinear regression, and many others. In addition, classification techniques can be used such as linear discriminant analysis (LDA), logistic regression (LR), classification and regression trees (CART), Gaussian mixture models (GMMs), k-nearest neighbors (k-NNs) classification, artificial neural networks (ANNs), deep neural networks (DNNs), convolutional neural networks (CNNs), support vector machines (SVMs), partial least-squares-discriminant analysis (PLS-DA), multilayer perceptron classifiers (MLPs), radial basis functions (RBFs), etc.

Other examples include feature extraction techniques such as genetic algorithms (GAs), feature subset selection (FSS), sequential forward selection (SFS), sequential backward selection (SBS), best-subset regression, etc.

The sensor module 112 can comprise any one or more of a position sensor, a proximity or distance sensor, and/or a location sensor. While the sensor module 112 has been illustrated as being associated with the exercise device 100, the sensor module 112 can be incorporated directly into the display screen 102.

Some example sensors that can be comprised in the sensor module 112 can comprise any one or more of an accelerometer, a potentiometric position sensor (resistance-based), an inductive position sensor, an eddy current-based position sensor, a capacitive position sensor, a magnetostrictive position sensor, a Hall effect-based magnetic position sensor, a fiber-optic position sensor, an optical position sensor, and/or an ultrasonic position sensor, as well as any other sensor(s) that would be known to one of ordinary skill in the art. The sensor module 112 can be configured to determine not only display screen parameters but also parameters of objects in relation to the exercise device 100 such as users or other exercise devices, as will be discussed in greater detail herein.

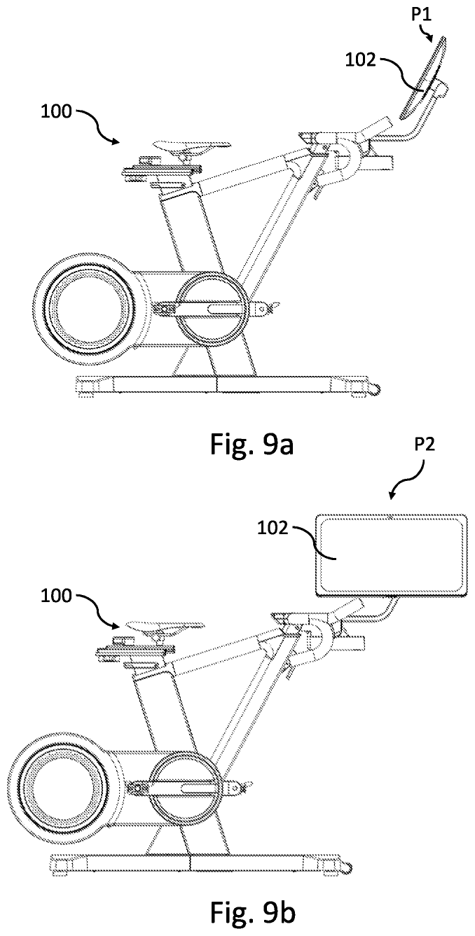

In some embodiments, the sensor module 112 can be a camera configured, for example through machine learning or AI algorithms, to detect images and, through the controller 110, recognize/determine the position of the display screen 102 with respect to the exercise device 100, i.e. whether the display screen is facing the exercise device 100, assuming the first position P1 (e.g. as shown in FIG. 9a) or the display screen is facing away the exercise device 100, assuming the second position P2 (e.g. as shown in FIG. 9b).

In this regard, a variety of camera types may be used such as an RGB camera, an RGB-D camera, a 2D camera, a 3D camera, a depth-camera, a stereo-camera, a time-of-flight (TOF) camera, webcam, and motorized camera.

The camera features may include sensor resolution (e.g. 5 MP, 8 MP, 16 MP, 1080p, 4 k), focal length (e.g. wide-angle, short telephoto, medium telephoto, super telephoto), aperture range (e.g. f/1.8, f/4, f/16), field-of-view (FoV) (e.g. 90°, 120°, 180°), aspect ratio (es. square, portrait, landscape, panorama), frame rate (e.g. 30 FPS, 50 FPS, 60 FPS), focus type (es. auto-focus, manual-focus, fixed-focus), and mounting type (integrated, built-in, embedded, standalone).

In addition, a variety of microphone types may be used together with the camera such as a dynamic microphone, a condenser microphone, a ribbon microphone.

The microphone features may include response type (flat, coloured), frequency response (e.g. 50 Hz-15,000 Hz), sensitivity, maximum sound pressure level (SPL), total harmonic distortion (THD), rated impedance, minimum load impedance, noise level, polar pattern (omnidirectional, unidirectional, bidirectional, cardioid, supercardioid), mounting type (integrated, built-in, embedded, standalone).

According to some embodiments, one or multiple cameras and/or microphones may be used.

In addition, according to some embodiments, one or multiple locations of one or more cameras may be used such as front, top, and bottom.

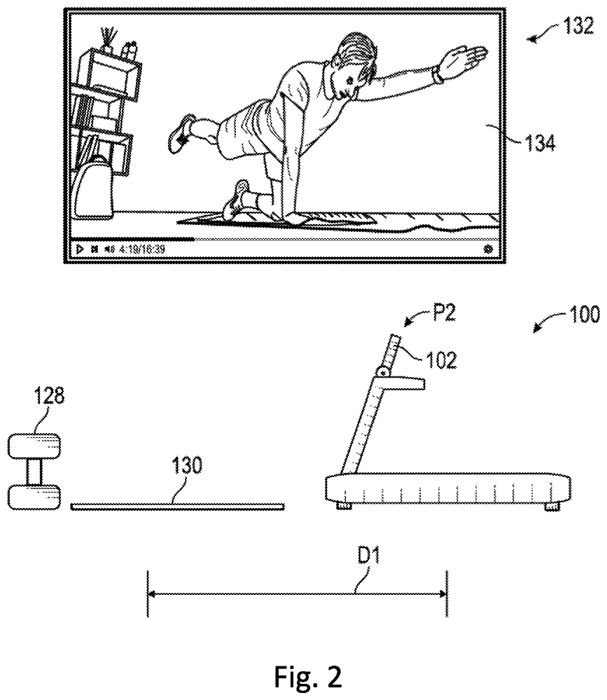

Depending on the type of sensor comprised, the sensor module 112 can output one or more types of signals that can be read by the controller 110 to determine any of position, proximity, location, and/or orientation of the display screen 102. Using the example of FIG. 1, the display screen 102 is illustrated in a first position P1 where the display screen 102 is oriented so as to be viewable by a user who is running or walking on the exercise device 100 (e.g., treadmill). In this example, the display screen 102 is pivotally/rotatably coupled to the frame 108 of the exercise device 100 using a mounting mechanism 120. The mounting mechanism 120 can comprise any device that couples the display screen 102 to the frame 108 while still allowing the display screen 102 to pivot, rotate, and/or swivel from the first position P1 to a second position P2 (see FIG. 2). Thus, the display screen is associated with an exercise device and the display screen is selectively positionable relative to a frame of the exercise device.

When the display screen 102 is in the first position P1 the display screen 102 can present a user interface 122 that comprises content 124 such as an instructional video. The user interface 122 can comprise an element such as buttons, sliders, toggles, or other actuators for controlling one or more parameters of the exercise device 100. For example, an element 125 can be utilized to select an incline for the treadmill. When the exercise device 100 is a treadmill the one or more parameters can comprise speed, incline, start/stop, and so forth.

According to some embodiments, content 124 can comprise motion tracking features which can be provided to the user in any form such as, audio feedback, visual feedback, real-time feedback and so on.

Using an AI hardware accelerometer as controller 110 advantageously allows to provide the motion tracking features to the user as real-time feedback.

As already indicated above, motion tracking features to be provided to the user may include exercise recognition, exercise classification, repetitions (reps) counting, series counting, pace evaluation, range-of-motion (ROM) evaluation, posture analysis, form feedback, body diagnosis, body segmentation, body recognition, gesture recognition, face recognition, motion detection, motion tracking, pose estimation, skeletal analysis, heart rate (HR) detection, fatigue detection, sex detection, race detection, body mass index (BMI) analysis.

In general, the controller 110 can be configured to determine a position of the display screen 102 in relation to the exercise device 100. The controller 110 can select a first type of content to display on the display screen 102 when the position of the display screen 102 is in a first position P1.

FIGS. 1 and 2 collectively illustrate the combined use of a second exercise device (e.g., workout equipment) such as a connected dumbbell 128 and mat 130. The connected dumbbell 128 and mat 130 can be located in proximity to the exercise device 100. The display screen 102 has been rotated from the first position P1 in FIG. 1 to a second position P2 in FIG. 2. Thus, the display screen 102 faces the connected dumbbell 128 and mat 130. As the sensor module 112 senses rotation of the display screen 102, the sensor module 112 outputs signals to the controller 110. The controller 110 determines from the signals that the display screen 102 is in the second position P2. Based on this position change, the controller 110 provides a second user interface 132 and selectively adjusts content being displayed on the display screen 102 to a second type of content 134. The second type of content 134 can comprise any exercise that involves the connected dumbbell 128, the mat 130, yoga, or a bodyweight exercise—just to name a few. Thus, the controller 110 can select a second type of content to display on the display screen 102 when the position of the display screen 102 is in a second position. To be sure, in this example, the second type of content 134 comprises instruction for another exercise that does not utilize the exercise device 100.

In sum, with respect to the embodiment of FIGS. 1, 2 and 9a, 9b, the first position P1 for the display screen 102 is associated with times when the display screen 102 is facing towards a user who is associated with the exercise device 100 and the second position P2 is associated with times when the display screen 102 is facing towards the user who is positioned away from the exercise device 100.

Rather than relying on a rotated position of the display screen 102, the sensor module 112 can detect the proximity of a user or another piece of workout equipment to the exercise device 100. For example, the sensor module 112 can comprise a proximity sensor that is configured to detect the presence of an object, such as the user. An example proximity sensor can comprise a camera that can capture images of a user or other objects. The controller 110 can implement image or object recognition to identify specific objects. The proximity sensor can also comprise, for example, an ultrasonic sensor, a laser (such as LiDAR “light detection and ranging”), or other similar sensors that are capable of detecting and measuring a distance or space between two objects. The proximity sensor can be integrated into the display screen 102 itself or into the exercise device.

When the proximity of the user is greater than a specified distance D1 from the exercise device 100, the user can be determined to be exercising independently from the exercise device 100. For example, if the proximity sensor senses that the user is exercising more than a specified distance away from the exercise device 100 the controller 110 can cause the display of a second (or other) type of content to the user. This would allow a user to set up a mat and/or dumbbells behind the exercise device 100. The user would not have to rotate the display screen 102 in this example, but the selection of content would be based on increased proximity between the user and the exercise device 100.

According to an embodiment, the sensor module 112 can be a camera configured, e.g. through machine learning or AI algorithms, to detect images and, via the controller 110, to recognize/determine the position of the display screen 102 with respect to the exercise device 100, i.e. recognizing/determining whether the display screen 102 is facing towards the exercise device 100 (first position P1) or not (second position P2) and/or the position of the user with respect to the exercise device 100, i.e. recognizing/determining if the user is on the exercise device 100 or next to the exercise device 100, in order to perform exercises without using the exercise device 100.

Examples of camera and/or microphone have been previously described.

According to an embodiment, the controller 110 can comprise a position detector module/motion tracking module.

In this embodiment, the controller 110 is further configured to process position detection/motion tracking function, for example, using machine-learning or AI algorithms.

Said function is activated only when the user is not using the exercise device, e.g. it is activated automatically based on the images detected by the camera: position of the display screen 102 and/or position of the user with respect to the exercise device 100.

In this way, there is the advantage of detecting and storing user activity when away from the exercise device 100, which otherwise would not be possible.

Alternatively, said function could be activated to detect/store the activity on the exercise device 100 and provide the user with information that the machine would not be able to detect, such as, for example, the posture of the user on a bike (e.g. the user can pedal sitting or standing on the pedals), the transition between sitting and standing position and/or any exercises for the upper body (e.g. using handlebars or dumbbells), while pedaling.

It will be understood that the movements of the display screen 102 that can result in a change of content displayed can comprise rotation, pivoting, hinging or any other similar translation in any axis such as horizontal, vertical, and/or combinations thereof. It will also be understood that more than two positions can be configured. For example, the display screen can present three or more different types of content that are context/position-dependent. If display screen position, proximity, location, orientation, and the like cannot be determined a default workout can be provided on the display screen.

According to an embodiment, the sensor module 112, e.g. a camera associated with the display screen 102 or integrated in the display screen 102, is configured to detect the movement of the display screen 102 on the basis of an analysis, by the controller 110, of images detected by the camera.

As an example, with reference to FIGS. 9a and 9b, when the display screen 102 is in the first position P1 (FIG. 9a), i.e. facing towards the exercise device 100, the camera detects images of the exercise device 100 (a bike) and/or images of a user (not shown in the FIG. 9a) on the exercise device 100, performing activity with the exercise device 100. On the contrary, when the display screen 102 is in the second position P2 (FIG. 9b), i.e. facing towards on one side of the exercise device 100, away from the exercise device 100, the camera detects images of the space and/or location around the exercise device 100 without the exercise device 100 and/or images of the user performing activity without using the exercise device 100.

Analyzing the above-mentioned images, the controller 112, passing from images of the exercise device 100 and/or images of a user on the exercise device 100, performing activity with the exercise device 100 to images of the space and/or location around the exercise device 100 without the exercise device 100 and/or images of the user performing activity without using the exercise device 100, is able to recognize that a rotation of the display screen 102 occurred.

According to another embodiment, the sensor module 112 could also detect the use of the connected dumbbell 128 by the user. The proximity sensor of the sensor module 112 can detect the presence and/or use of a second exercise device (such as the connected dumbbell 128) relative to a specified distance, such as D1, from the exercise device 100. In one example, the display screen 102 can display a dumbbell workout when the user approaches the display screen 102 while holding the connected dumbbell 128. The sensor module 112 can utilize a proximity sensor such as a Bluetooth sensor to sense the connected dumbbell 128.

In another example, the controller 110 can selectively change the content provided on the display screen 102 when the user returns to use the exercise device 100. That is, when the proximity of the user to the exercise device 100 is outside of the specified distance D1, a second type of content is displayed on the display screen 102. When the proximity of the user to the exercise device 100 returns to being within the specified distance D1, a first type of content is again displayed on the display screen 102.

It should be noted that the controller 110 can detect when the user is on the exercise device 100 receiving a signal from a vibration sensor (e.g. an accelerometer), with which the exercise device 100 can be equipped, operatively connected to the controller 110. In this embodiment, the user is detected, by the controller 110, when the user begins movements on the exercise device 100.

In sum, in general, content for the display screen can be selected or changed from one type to another based on a change in position of the display screen such as rotating, hinging, swiveling, pivoting, and the like. In some embodiments, content for the display screen can be selected or changed from one type to another based on the movement of the display screen from one location to another location. In additional embodiments, the content for the display screen can be selected or changed from one type to another based on proximity between a user and the display screen or between the display screen and an exercise device. Further, the content for the display screen can be selected or changed from one type to another based on any combination of the above.

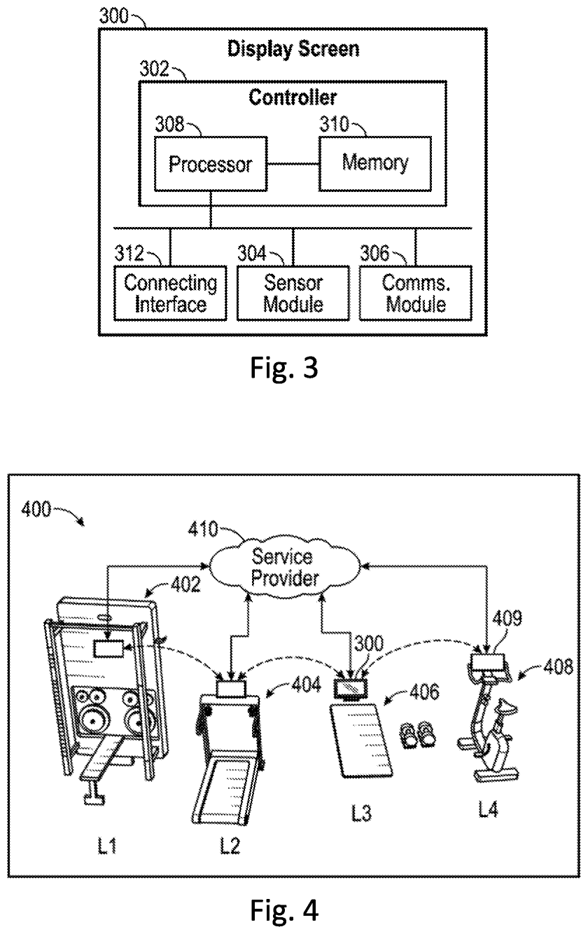

FIG. 3 is a schematic diagram of an example display screen 300. The display screen 300 can comprise a controller 302, a sensor module 304, and a communications module 306 that allows the display screen 300 (and specifically the controller 110) to access and communicate over a network (see network 106 of FIG. 1). For example, the display screen 300 can communicate over the network with a service provider or an exercise device (see FIG. 4).

The controller 302 can comprise a processor 308 and memory 310 for storing executable instructions. The processor 308 executes instructions stored in the memory 310 to perform functions such as determining display screen position, proximity, location, orientation, and the like, as well as determining content that should be displayed on the display screen 300. The display screen 300 can also comprise a connecting interface 312 that allows the display screen 300 to electrically and/or communicatively couple with an exercise device.

FIGS. 3 and 4 collectively illustrate another example use case where a location of a display screen 300 can dictate what content is displayed thereon. A plurality of exercise devices is present and can be associated with discrete locations in a workout area 400. Each of the exercise devices can have a dedicated display screen. An independent display screen, such as display screen 300, can be utilized by a user of the exercise devices. The user can place the display screen 300 next to an exercise device. Alternatively, the display screen 300 can be plugged into an electrical and/or communicative interface of the exercise device (if present). As illustrated in dotted line, the display screen 300 can be associated with the second exercise device 404, then the third exercise device 406, and then moved to the fourth exercise device 408. Any of the exercise devices 402, 404, and/or 408 can receive the display screen 300. Alternatively, one of more of the exercise devices may have a dedicated display screen. For example, the exercise device 408 can have a dock or holder 409 that receives the display screen 300. Each of the one of more of the exercise devices may have a similar dock or holder.

The workout area 400 can comprise a first exercise device 402 such as a weightlifting station, a second exercise device 404 such as a treadmill, a third exercise device 406 such as a mat and weights, and a fourth exercise device 408 such as a bicycle. Each of these exercise devices can be communicatively coupled with a service provider 410. The first exercise device 402 is associated with a first location L1. The second exercise device 404 is associated with a second location L2. The third exercise device 406 is associated with a third location L3, and a fourth exercise device 408 is associated with a fourth location L4. As the user moves the display screen 300 from location to location, the content displayed on the display screen 300 can change.

The service provider 410 can deliver content to the display screen 300 based on a relative location of the display screen 300 in a workout area. For example, the display screen 300 can provide location data to the service provider 410. The service provider 410 can determine the location of the display screen 300 in the workout area 400. For example, the display screen 300 can report its location as being within L3. In response, the service provider 410 can transmit content to the display screen 300 that corresponds to workouts for the user that involve the third exercise device 406. When the user moves the display screen 300 to L2, the service provider 410 can transmit content to the display screen 300 that corresponds to workouts for the user that involve the second exercise device 404. The content for the second exercise device 404 can be displayed along with user interfaces that allow the user to select exercise device parameters such as resistance, distance, and so forth. If a location of the display screen 300 cannot be determined, the service provider 410 can deliver a default workout to the display screen 300.

According to the present disclosure, a system 200 comprises a display screen 102 (300) associated with an exercise device 100.

The system 200 comprises a sensor module 112 (304) associated with the display screen 102 (300).

The system 200 comprises a controller 110 (302) having a processor 116 (308) and memory 118 (310) for storing instructions.

The processor 116 (308) executes the instructions to: based on output of the sensor module 112 (304), detect any one or more of position or proximity of the display screen 102 (300) in relation to the exercise device (100); and selectively change content displayed on the display screen 102 based on any one or more of the position and/or the proximity.

According to an embodiment, the display screen 102 (300) is selectively positionable relative to a frame 108 of the exercise device 100.

According to an embodiment, the processor 116 executing the instructions to: determine a position of the display screen 102 in relation to the exercise device 100; select a first type of content 124 to display on the display screen 102 when the position of the display screen 102 is in a first position P1; and select a second type of content 134 to display on the display screen 102 when the position of the display screen (102) is in a second position P2.

According to an embodiment, the controller 110 is configured to display the first type of content 124 as a first user interface 122, the first user interface 122. comprising an element for adjusting a parameter of the exercise device 100.

According to an embodiment, the second type of content 134 comprises instruction for another exercise that does not utilize the exercise device 100.

According to an embodiment, the first position P1 is when the display screen 102 is facing towards a user who is associated with the exercise device 100 and the second position P2 is when the display screen 102 is facing towards the user who is positioned away from the exercise device 100.

According to an embodiment, the sensor module 112 comprises a camera configured, e.g. through machine learning or AI algorithms, to detect images and, via the controller 110, to recognize/determine the position of the display screen 102 with respect to the exercise device 100, i.e. recognizing/determining whether the display screen 102 is facing towards the exercise device 100 (first position P1) or not (second position P2) and/or the position of the user with respect to the exercise device 100, i.e. recognizing/determining if the user is on the exercise device 100 or next to the exercise device 100, in order to perform exercises without using the exercise device 100.

Examples of camera and/or microphone have been previously described.

According to an embodiment, the controller 110 can comprise a position detector module/motion tracking module.

In this embodiment, the controller 110 is further configured to process position detection/motion tracking function, for example, using machine-learning or AI algorithms.

Said function is activated only when the user is not using the exercise device, e.g. it is activated automatically based on the images detected by the camera: position of the display screen 102 and/or position of the user with respect to the exercise device 100.

In this way, there is the advantage of detecting and storing user activity when away from the exercise device 100, which otherwise would not be possible.

Alternatively, said function could be activated to detect/store the activity on the exercise device 100 and provide the user with information that the machine would not be able to detect, such as, for example, the posture of the user on a bike (e.g. the user can pedal sitting or standing on the pedals), the transition between sitting and standing position and/or any exercises for the upper body (e.g. using handlebars or dumbbells), while pedaling.

According to an embodiment, the sensor module 112 (304) further comprises a proximity sensor that is configured to detect presence of a second exercise device 128, 130 that is within a specified distance from the exercise device 100.

According to an embodiment, the controller 110 selects the second type of content 134 based on the sensing of the presence of the second exercise device 128, 130.

According to a further embodiment, the controller 110 (302) selects the second type of content 134 based on the type of the second exercise device 128, 130.

According to an embodiment, the second position P2 is achieved when the display screen 102 has been rotated relative to the first position P1.

According to an embodiment, the controller 110 is configured to: select a first type of the content 124 when the sensor module 112 has detected that the display screen 102 is within a specified distance from the exercise device 100; and select a second type of the content 134 when the sensor module 112 has detected that the display screen 102 is within a specified distance from a second exercise device 128.

According to an embodiment, the controller 110 is configured to select the content based on a relative location L1, L2, L3, L4 of the display screen 102 within a workout area (400).

According to an embodiment, the controller 110 is configured to display a first type of content 124 as a first user interface 122 when the output of the sensor module 112 is indicative of the display screen 102 being in a first position P1 relative to the exercise device 100, the first user interface 122 comprising an element 125 for adjusting a parameter of the exercise device 100.

According to an embodiment, the first position P1 is when the display screen 102 is facing towards a user who is associated with the exercise device 100 and a second position P2 is when the display screen 102 is facing towards the user who is positioned away from the exercise device 100.

According to an embodiment, a second type of content 134 is displayed when the display screen 102 is in the second position P2, the second type of content 134 comprising instruction for another exercise that does not utilize the exercise device 100.

According to an embodiment, the display screen 102 is configured to mechanically couple with the frame 108 of the exercise device 100.

According to an embodiment, the display screen 102 is rotatably coupled to the frame 108.

According to an embodiment, the display screen 102 can rotate between a first position P1 and a second position P2.

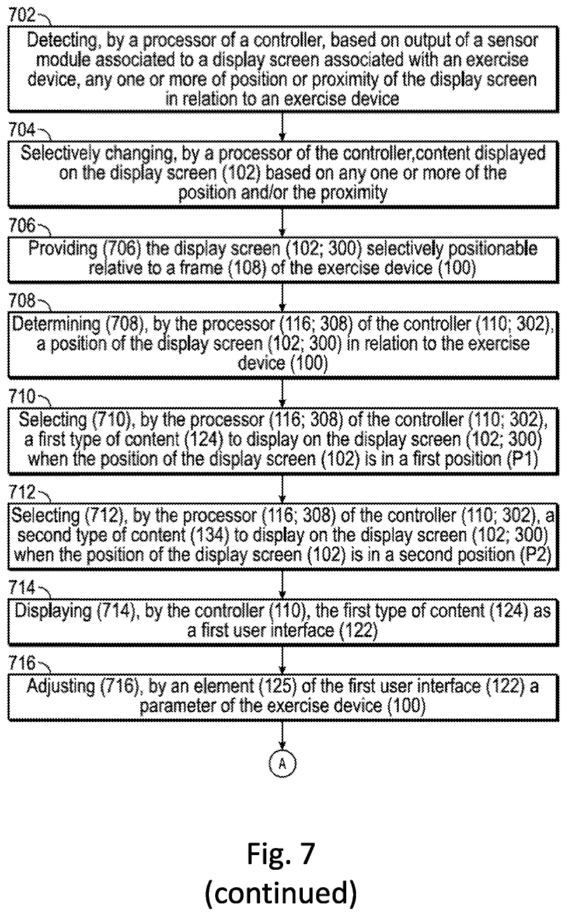

FIG. 5 is a flowchart of an example method of the present disclosure. The method can comprise a step 502 of receiving output from a sensor platform associated with a display screen. The output can comprise any combination of position, location, orientation, and/or proximity/distance. The method can comprise a step 504 of selecting content for display on the display screen based on at least one of a position of the display screen in relation to an exercise device, a distance of the display screen in relation to the exercise device, and/or a relative location of the display screen within a workout area.

The method can comprise a step 506 of detecting when the position of the display screen has been translated between a first position where the display screen faces a first direction and a second position where the display screen faces a second direction. As noted above, a first type of the content is displayed when the display screen faces the first direction and a second type of the content is displayed when the display screen faces the second direction. In various embodiments, a third type of the content is displayed when the display screen is moved away from the exercise device. For example, content related to a bodyweight workout can be displayed. The third type of the content can be based on the relative location of the display screen within the workout area. Continuing with the example, the content can be selected by determining that the display screen has been relocated to a location in the workout area where workout benches or mats are located.

In an embodiment, the step 506 of detecting comprising detecting, by a camera of the sensor module 112, e.g. through machine learning or AI algorithms, to images and, by the controller 110, recognizing/determining the position of the display screen 102 with respect to the exercise device 100, i.e. recognizing/determining whether the display screen 102 is facing towards the exercise device 100 (first position P1) or not (second position P2) and/or the position of the user with respect to the exercise device 100, i.e. recognizing/determining if the user is on the exercise device 100 or next to the exercise device 100, in order to perform exercises without using the exercise device 100.

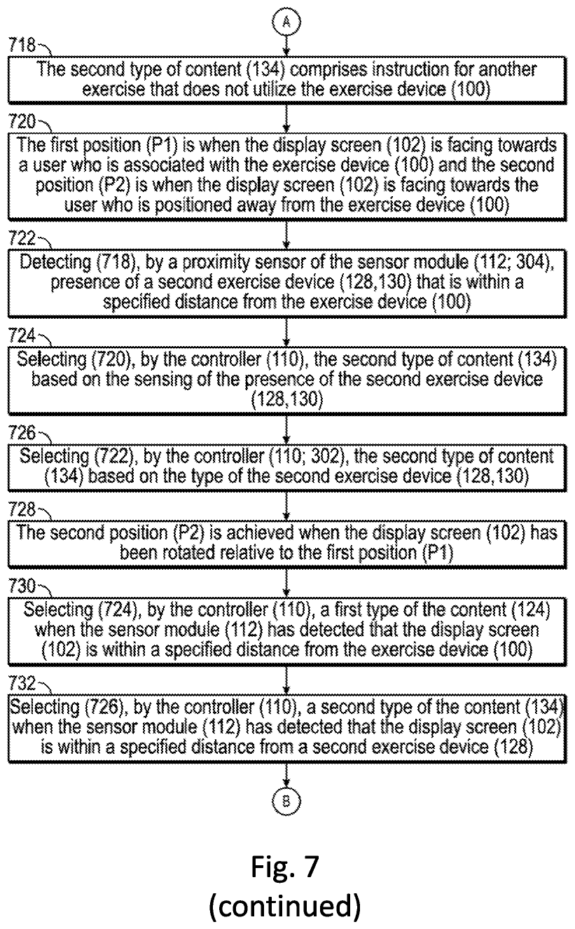

FIG. 6 is a flowchart of an example method of the present disclosure. The method can comprise a step 602 of determining proximity of a user or an exercise device to a display screen. For example, this can comprise determining that a user is within a specified distance to the display screen. In another example, this can include determining that an exercise device is in short-range wireless communication distance (e.g., within Bluetooth range) from the display screen.

Next, the method can comprise a step 604 of selecting content for display on the display screen based on the proximity of the user or the exercise device to the display screen. For example, when the user approaches with a connected dumbbell, the display screen can be configured to present a dumbbell workout video. In another example, when the user is determined to be within a specified distance to the display screen but no connected devices are found, the display screen can be configured to present a yoga or bodyweight workout video.

This method can also comprise limitations for selectively changing the content displayed on the display screen based on changes in position, orientation, or location of the display screen. For example, the display screen can be associated with an exercise device, such as a treadmill. The user flips the display screen by rotating the display screen vertically or horizontally. The content presented on the display screen can change based on this screen flip. Thus, the method can comprise a step 606 of determining a change in any of position, orientation, or location of the display screen, as well as a step 608 of changing content that is displayed on the display screen based on the change in position, orientation, or location.

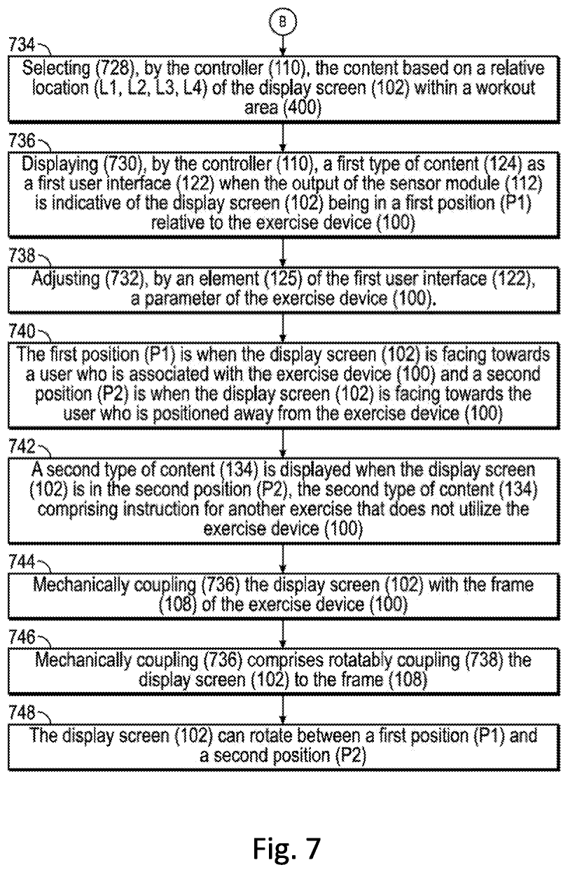

FIG. 7 is a flowchart of another example method. The method can generally comprise a step 702 of detecting, by a processor of a controller, based on output of a sensor module (associated to a display screen associated with an exercise device, any one or more of position or proximity of the display screen in relation to an exercise device. The method can also comprise a step 704 selectively changing, by a processor of the controller, content displayed on the display screen based on any one or more of the position and/or the proximity.

According to an embodiment, the method can comprise determining 708, by the processor of the controller, a position of the display screen in relation to the exercise device 100. The method can comprises selecting 710, by the processor of the controller, a first type of content 124 to display on the display screen 102, 300 when the position of the display screen 102 is in a first position P1. The method can comprise selecting 712, by the processor of the controller, a second type of content 134 to display on the display screen when the position of the display screen 102 is in a second position P2.

According to an embodiment, the method can comprise displaying 714, by the controller, the first type of content 124 as a first user interface 122. The method can comprise adjusting 716, by an element 125 of the first user interface 122 a parameter of the exercise device 100.

According to an embodiment, the second type of content 134 comprises instruction for another exercise that does not utilize the exercise device 100.

According to an embodiment, the first position P1 is when the display screen 102 is facing towards a user who is associated with the exercise device 100 and the second position P2 is when the display screen 102 is facing towards the user who is positioned away from the exercise device 100.

According to an embodiment, the method can comprise detecting 718, by a proximity sensor of the sensor module, presence of a second exercise device that is within a specified distance from the exercise device 100.

According to an embodiment, the method can comprise selecting 720, by the controller, the second type of content 134 based on the sensing of the presence of the second exercise device.

According to an embodiment, the method can comprise selecting 722, by the controller, the second type of content 134 based on the type of the second exercise device.

According to an embodiment, the second position P2 is achieved when the display screen 102 has been rotated relative to the first position (P1).

According to an embodiment, the method can comprise selecting 724, by the controller, a first type of the content 124 when the sensor module has detected that the display screen 102 is within a specified distance from the exercise device 100. The method can comprise selecting 726, by the controller, a second type of the content 134 when the sensor module 112 has detected that the display screen 102 is within a specified distance from a second exercise device.

According to an embodiment, the method can comprise selecting 728, by the controller, the content based on a relative location L1, L2, L3, L4 of the display screen 300 within a workout area (400).

According to an embodiment, the method can comprise displaying 730, by the controller, a first type of content 124 as a first user interface 122 when the output of the sensor module is indicative of the display screen being in a first position P1 relative to the exercise device 100. The method can comprise adjusting 732, by an element 125 of the first user interface 122, a parameter of the exercise device 100.

According to an embodiment, the first position P1 is when the display screen 102 is facing towards a user who is associated with the exercise device 100 and a second position P2 is when the display screen 102 is facing towards the user who is positioned away from the exercise device 100.

According to an embodiment, a second type of content 134 is displayed when the display screen 102 is in the second position P2, the second type of content 134 comprising instruction for another exercise that does not utilize the exercise device 100.

According to an embodiment, the method can comprise a step of mechanically coupling 736 the display screen 102 with the frame 108 of the exercise device (100).

According to an embodiment, the step of mechanically coupling 736 comprises a step of rotatably coupling 738 the display screen 102 to the frame 108.

According to an embodiment, the display screen 102 can rotate between a first position P1 and a second position P2.

Another example system 200 can comprise a display screen 102 associated with an exercise device 100, the display screen 102 that is selectively positionable relative to a frame 108 of the exercise device 100, a position sensor 112 associated with the display screen 102, and a controller 110 having a processor 116 and memory 118 for storing instructions, the processor 116 executing the instructions to determine a position of the display screen 102 in relation to the exercise device 100, select a first type of content 124 to display on the display screen 102 when the position of the display screen 102 is in a first position P1, and select a second type of content 134 to display on the display screen 102 when the position of the display screen 102 is in a second position P2.

A controller 110 is configured to display the first type of content 124 as a first user interface 122, the first user interface 122 comprising an element for adjusting a parameter of the exercise device 100. Also, the second type of content 134 comprises instruction for another exercise that does not utilize the exercise device 100.

The first position P1 is when the display screen 102 is facing towards a user who is associated with the exercise device 100 and the second position P2 is when the display screen 102 is facing towards the user who is positioned away from the exercise device 100. A proximity sensor can be configured to detect presence of a second exercise device 128, 130 that is within a specified distance from the exercise device 100. The controller 110 selects the second type of content 134 based on the sensing of the presence of the second exercise device 128, 130.

An example device of the present disclosure can comprise a display screen 300, a sensor module 304 associated with the display screen 300, and a controller 302 having a processor 308 and memory 310 for storing instructions, the processor 308 executing the instructions to (based on output of the sensor module 304) detect any one or more of position or proximity of the display screen 300 in relation to an exercise device, and selectively change content displayed on the display screen 300 based on any one or more of the position and/or the proximity.

The controller 110 is configured to select a first type of the content 124 when the sensor module 112 has detected that the display screen 102 is in a first position P1 relative to the exercise device 100 and select a second type of the content 134 when the sensor module 112 has detected that the display screen 102 is in a second position P2 relative to the exercise device 100, the second position P2 being achieved when the display screen 102 has been rotated relative to the first position P1.

The controller 110 is configured to select a first type of the content 124 when the sensor module 112 has detected that the display screen 102 is within a specified distance from the exercise device 100 and select a second type of the content 134 when the sensor module 112 has detected that the display screen 102 is within a specified distance from a second exercise device 128, 130.

The controller 110 is configured to select the content based on a relative location L1, L2, L3, L4 of the display screen within a workout area 400. The controller 110 is configured to display a first type of content 124 as a first user interface 122 when the output of the sensor module 112 is indicative of the display screen 102 being in a first position P1 relative to the exercise device 100, the first user interface 122 comprising an element 125 for adjusting a parameter of the exercise device 100.

The first position P1 is when the display screen 102 is facing towards a user who is associated with the exercise device 100 and a second position P2 is when the display screen 102 is facing towards the user who is positioned away from the exercise device 100. A second type of content 134 is displayed when the display screen 102 is in the second position P2, the second type of content 134 comprising instruction for another exercise that does not utilize the exercise device 100.

The display screen 102 is configured to mechanically couple with a frame 108 of the exercise device 100. The display screen 102 is rotatably coupled to a frame 108. The display screen 102 can rotate (vertically and/or horizontally or in any plane) between a first position P1 and a second position P2.

A method can comprise receiving 502 output from a sensor platform 112 associated with a display screen 102, selecting 504 content for display on the display screen 102 based on at least one of a position of the display screen 102 in relation to an exercise device 100, a distance of the display screen 102 in relation to the exercise device 100 and/or a relative location of the display screen 102 within a workout area 400.

The method can comprise detecting 506 when the position of the display screen 102 has been translated between a first position P1 where the display screen 102 faces a first direction and a second position where the display screen 102 faces a second direction.

In an embodiment, the step 506 of detecting comprising detecting, by a camera of the sensor module 112, e.g. through machine learning or AI algorithms, to images and, by the controller 110, recognizing/determining the position of the display screen 102 with respect to the exercise device 100, i.e. recognizing/determining whether the display screen 102 is facing towards the exercise device 100 (first position P1) or not (second position P2) and/or the position of the user with respect to the exercise device 100, i.e. recognizing/determining if the user is on the exercise device 100 or next to the exercise device 100, in order to perform exercises without using the exercise device 100.

A first type of the content 124 is displayed when the display screen 102 faces the first direction and a second type of the content 134 is displayed when the display screen 102 faces the second direction. A third type of the content is displayed when the display screen 300 is moved away from the exercise device, the third type of the content being based on the relative location L1, L2, L3, L4 of the display screen 300 within the workout area 400.

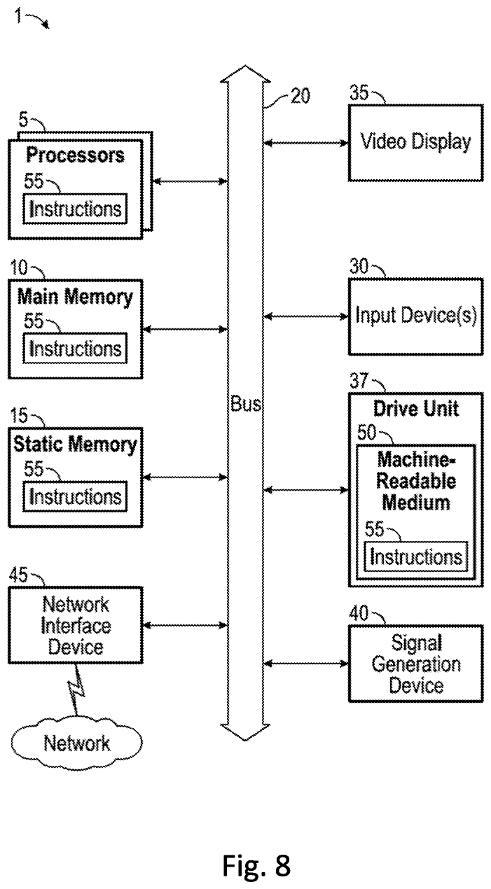

FIG. 8 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 comprises a processor or multiple processor(s) 5 (e.g., a central processing unit (CPU), a graphics processing unit (GPU), or both), and a main memory 10 and static memory 15, which communicate with each other via a bus 20. The computer system 1 may further comprise a video display 35 (e.g., a liquid crystal display (LCD)). The computer system 1 may also comprise an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further comprise a data encryption module (not shown) to encrypt data.

The drive unit 37 comprises a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 can be machine learning instructions and/or machine learning algorithm (e.g. regression, classification, ANNs, CNNs, and so on).

The main memory 10, the static memory 15 and the computer or machine-readable medium 50 of the driver unit 37 can store machine learning instructions.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 are those typically found in computer systems that may be suitable for use with embodiments of the present disclosure and are intended to represent a broad category of such computer components that are well known in the art. Thus, the computer system 1 can be a personal computer (PC), hand held computer system, telephone, mobile computer system, workstation, tablet, phablet, mobile phone, server, minicomputer, mainframe computer, wearable, or any other computer system. The computer may also comprise different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself comprise a cloud-based computing environment, where the functionalities of the computer system 1 are executed in a distributed fashion. Thus, the computer system 1, when configured as a computing cloud, may comprise pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++ or the like and conventional procedural programming languages, such as the “C” programming language or similar programming languages. Computer program code for carrying operations for aspects of the present technology using artificial intelligence may be written in a specific programming language, e.g. Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1-36. (canceled)

37. A system comprising:
a display screen associated with an exercise device;
a sensor module associated with the display screen; and
a controller having a processor and memory for storing instructions, the processor executing the instructions to:
based on output of the sensor module, detect any one or more of position or proximity of the display screen in relation to the exercise device; and
selectively change content displayed on the display screen based on any one or more of the position and/or the proximity.

38. The system according to claim 37, wherein the display screen is selectively positionable relative to a frame of the exercise device.

39. The system according to claim 37, wherein the processor executing the instructions to:
determine a position of the display screen in relation to the exercise device;
select a first type of content to display on the display screen when the position of the display screen is in a first position; and
select a second type of content to display on the display screen when the position of the display screen is in a second position.

40. The system according to claim 39, wherein the controller is configured to display the first type of content as a first user interface, the first user interface comprising an element for adjusting a parameter of the exercise device, the second type of content comprising instruction for another exercise that does not utilize the exercise device.

41. The system according to claim 39, wherein the first position is when the display screen is facing towards a user who is associated with the exercise device and the second position is when the display screen is facing towards the user who is positioned away from the exercise device.

42. The system according to claim 37, wherein the sensor module further comprises a proximity sensor that is configured to detect presence of a second exercise device that is within a specified distance from the exercise device, and the controller selects the second type of content based on the sensing of the presence of the second exercise device or the type of the second exercise device.

43. The system according to claim 39, wherein the second position is achieved when the display screen has been rotated relative to the first position.

44. The system according to claim 37, wherein when the controller is configured to:
select a first type of the content when the sensor module has detected that the display screen is within a specified distance from the exercise device; and
select a second type of the content when the sensor module has detected that the display screen is within a specified distance from a second exercise device.

45. The system according to claim 37, wherein the controller is configured to select the content based on a relative location of the display screen within a workout area.

46. The system according to claim 37, wherein the controller is configured to display a first type of content as a first user interface when the output of the sensor module is indicative of the display screen being in a first position relative to the exercise device, the first user interface comprising an element for adjusting a parameter of the exercise device, the first position being when the display screen is facing towards a user who is associated with the exercise device and a second position is when the display screen is facing towards the user who is positioned away from the exercise device.

47. The system according to claim 42, wherein a second type of content is displayed when the display screen is in the second position, the second type of content comprising instruction for another exercise that does not utilize the exercise device.

48. The system according to claim 38, wherein the display screen is configured to mechanically or rotatably couple with the frame of the exercise device, and the display screen can rotate between a first position and a second position.

49. A method comprising:
detecting, by a processor of a controller, based on output of a sensor module associated to a display screen associated with an exercise device, any one or more of position or proximity of the display screen in relation to an exercise device; and
selectively changing, by the processor of the controller, content displayed on the display screen based on any one or more of the position and/or the proximity.

50. The method according to claim 49, comprising:
providing the display screen selectively positionable relative to a frame of the exercise device.

51. The method according to claim 49, comprising:
determining, by the processor of the controller, a position of the display screen in relation to the exercise device;
selecting, by the processor of the controller, a first type of content to display on the display screen when the position of the display screen is in a first position;
selecting, by the processor of the controller, a second type of content to display on the display screen when the position of the display screen is in a second position;
displaying, by the controller, the first type of content as a first user interface; and
adjusting, by an element of the first user interface a parameter of the exercise device.

52. The method according to claim 51, wherein the first position is when the display screen is facing towards a user who is associated with the exercise device and the second position is when the display screen is facing towards the user who is positioned away from the exercise device.

53. The method according to claim 51, wherein the second position is achieved when the display screen has been rotated relative to the first position.

54. The method according to claim 53, comprising:
selecting, by the controller, a first type of the content when the sensor module has detected that the display screen is within a specified distance from the exercise device; and
selecting, by the controller, a second type of the content when the sensor module has detected that the display screen is within a specified distance from a second exercise device.

55. The method according to claim 54, comprising:
selecting, by the controller, the content based on a relative location of the display screen within a workout area;
displaying, by the controller, a first type of content as a first user interface when the output of the sensor module is indicative of the display screen being in a first position relative to the exercise device; and
adjusting, by an element of the first user interface, a parameter of the exercise device, the first position being when the display screen is facing towards a user who is associated with the exercise device and a second position being when the display screen is facing towards the user who is positioned away from the exercise device.

56. The method according to claim 49, further comprising mechanically or rotatably coupling the display screen with the frame of the exercise device and the display screen can rotate between a first position and a second position, a second type of content being displayed when the display screen is in the second position, the second type of content comprising instruction for another exercise that does not utilize the exercise device.
